(19) United States
(12) Patent Application Publication
(10) Pub. No.: US 2026/0214710 A1
(43) Pub. Date: Jul. 23, 2026

(54) DATA TRANSMISSION METHOD AND DEVICE, AND STORAGE MEDIUM

(71) Applicant: ZTE CORPORATION, Shenzhen, Guangdong (CN)

(72) Inventor: Yan LI, Shenzhen (CN)

(21) Appl. No.: 19/138,734

(22) PCT Filed: Aug. 18, 2023
(86) PCT No.: PCT/CN2023/113764

§ 371 Date: Jun. 13, 2025

(30) Foreign Application Priority Data
Dec. 14, 2022 (CN) 202211610410.9

(51) Int. Cl. H04W 74/0816

(52) U.S. Cl. CPC H04W 74/0816

(57) ABSTRACT

Provided are a data transmission method, a device, and a storage medium. Provided are a data transmission method, a device, and a storage medium. A data transmission method applied to a first communication node in a first basic service set includes sending a multi-user request-to-send message to a communication node in a second basic service set to enable the communication node in the second basic service set to perform data transmission (S410).

### CROSS-REFERENCE TO RELATED APPLICATION

This is a national stage application filed under 35 U.S.C. 371 based on International Patent Application No. PCT/CN2023/113764, filed on Aug. 18, 2023, which is based on and claims priority to a Chinese Patent Application No. 202211610410.9 filed on Dec. 14, 2022, disclosures of which are incorporated herein by reference in their entireties.

### TECHNICAL FIELD

The present application relates to the field of communication technology, for example, to a data transmission method, a device, and a storage medium.

### BACKGROUND

In Distributed Transmission Opportunity Sharing (D-TXS) technology, transmission opportunity (TXOP) resources are allocated to multiple access points (APs) for low-latency data transmission, thereby achieving multi-AP collaboration, enhancing the overall low-latency transmission capability of the multi-AP system, and reducing data transmission latency. However, a technical drawback of hidden nodes exists.

FIG. 1 is a diagram of interactions in a communication scenario provided by related art. As shown in FIG. 1, in Basic Service Set 1 (BSS1), Station 1 (STA1) is associated with AP1, and in BSS2, STA2 is associated with AP2. In BSS1, AP1 obtains a TXOP and allocates a time window to AP2. During the low-latency communication of AP2, STA2 in BSS2 is sending uplink transmission data to AP2. Since STA2 is outside the coverage range of BSS1, STA2 cannot receive the time window information allocated by AP1 to AP2. If the TXOP of STA2 has not ended within this time window, AP2 cannot occupy the time window for low-latency transmission. For AP1, no data transmission occurs in the time window allocated to AP2, resulting in a waste of air interface resources.

### SUMMARY

Embodiments of the present application provide a data transmission method, a device, and a storage medium to avoid the waste of air interface resources.

An embodiment of the present application provides a data transmission method applied to a first communication node located in a first basic service set. The method includes the operation below.

A multi-user request-to-send message is sent to a communication node in a second basic service set to enable the communication node in the second basic service set to perform data transmission.

An embodiment of the present application provides a data transmission method applied to a second communication node located in a second basic service set. The method includes the operations below.

A multi-user request-to-send message sent by a first communication node in a first basic service set is received. Data transmission is performed based on the multi-user request-to-send message.

An embodiment of the present application provides a data transmission apparatus applied to a first communication node located in a first basic service set. The apparatus includes a transmitter.

The transmitter is configured to send a multi-user request-to-send message to a communication node in a second basic service set to enable the communication node in the second basic service set to perform data transmission.

An embodiment of the present application provides a data transmission apparatus applied to a second communication node located in a second basic service set. The apparatus includes a receiver and a data transmission module.

The receiver is configured to receive a multi-user request-to-send message sent by a first communication node in a first basic service set. The data transmission module is configured to perform data transmission based on the multi-user request-to-send message.

An embodiment of the present application provides a communication device. The device includes a memory and one or more processors.

The memory is configured to store one or more programs. When executed by the one or more processors, the one or more programs cause the one or more processors to perform the data transmission method described in any of the preceding embodiments.

An embodiment of the present application provides a storage medium. The storage medium stores a computer program that, when executed by a processor, implements the data transmission method described in any of the preceding embodiments.

### BRIEF DESCRIPTION OF DRAWINGS

FIG. 1 is a diagram of interactions in a communication scenario provided by related art.

FIG. 2 is a diagram of communication between an access point and stations in a single BSS provided by related art.

FIG. 3 is a diagram of an implementation of a D-TXS process according to an embodiment of the present application.

FIG. 4 is a flowchart of a data transmission method according to an embodiment of the present application.

FIG. 5 is a flowchart of another data transmission method according to an embodiment of the present application.

FIG. 6 is a diagram of communication for real-time allocation of a D-TXS service period according to an embodiment of the present application.

FIG. 7 is a diagram of a frame structure of a multi-user request-to-send message according to an embodiment of the present application.

FIG. 8 is a diagram of another frame structure of a multi-user request-to-send message according to an embodiment of the present application.

FIG. 9 is a diagram of communication for reservation allocation of a D-TXS service period according to an embodiment of the present application.

FIG. 10 is a diagram of yet another frame structure of a multi-user request-to-send message according to an embodiment of the present application.

FIG. 11 is a diagram of still another frame structure of a multi-user request-to-send message according to an embodiment of the present application.

FIG. 12 is a diagram of a frame structure of a D-TXS service period element according to an embodiment of the present application.

FIG. 13 is a diagram of a frame structure of a quiet element according to an embodiment of the present application.

FIG. 14 is a diagram of communication interactions between a variant MU-RTS message and a CTS message according to an embodiment of the present application.

FIG. 15 is a diagram of another communication interaction between a variant MU-RTS message and a CTS message according to an embodiment of the present application.

FIG. 16 is a diagram of yet another communication interaction between a variant MU-RTS message and a CTS message according to an embodiment of the present application.

FIG. 17 is a diagram illustrating that a primary AP performs medium detection during a service period of a subordinate AP according to an embodiment of the present application.

FIG. 18 is a diagram of an implementation of a transmission completion notification of a subordinate AP according to an embodiment of the present application.

FIG. 19 is a diagram of communication between APs and STAs across BSSs according to an embodiment of the present application.

FIG. 20 is a block diagram illustrating the structure of a data transmission apparatus according to an embodiment of the present application.

FIG. 21 is a block diagram illustrating the structure of another data transmission apparatus according to an embodiment of the present application.

FIG. 22 is a diagram illustrating the structure of a communication device according to an embodiment of the present application.

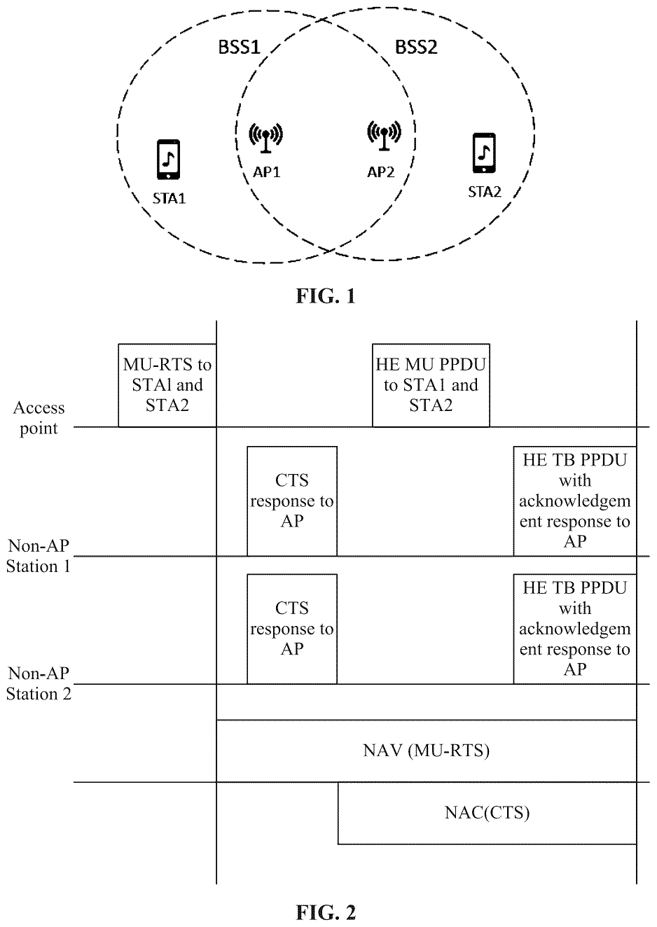

### DETAILED DESCRIPTION

Embodiments of the present application are described below in conjunction with drawings. The present application is described below in conjunction with accompanying drawings of the embodiments. The examples given are only used to explain the present application.

FIG. 2 is a diagram of communication between an access point and stations in a single BSS provided by related art. As shown in FIG. 2, the communication interaction process between an access point and stations in a single BSS includes the following:

First, the AP sends a Multi-User Request to Send (MU-RTS) message in a broadcast manner. The MU-RTS message carries user information (user info) directed to STA1/STA2 to enable STA1/STA2 to respond with a Clear to Send (CTS) message on the required frequency domain.

Then, STA1/STA2 performs virtual carrier sense (virtual CS) and energy detection-based clear channel assessment (ED-based CCA) within the Short Inter Frame Space (SIFS) after receiving the MU-RTS message. If the medium is confirmed to be idle, STA1/STA2 responds with a CTS message. The response of the CTS message resolves the problem of hidden nodes (the hidden node refers to a node that can receive messages sent by STA1/STA2 but cannot receive messages sent by the AP; at this time, the hidden node confirms through the CTS message that other devices are communicating with STA1/STA2 and thus sets its Network Allocation Vector (NAV) through the CTS message and refrains from actively contending for the TXOP).

Finally, after receiving the CTS message from STA1/STA2, the AP confirms that the medium is idle, and subsequent uplink/downlink (UL/DL) orthogonal frequency-division multiple access (OFDMA) transmission can be performed.

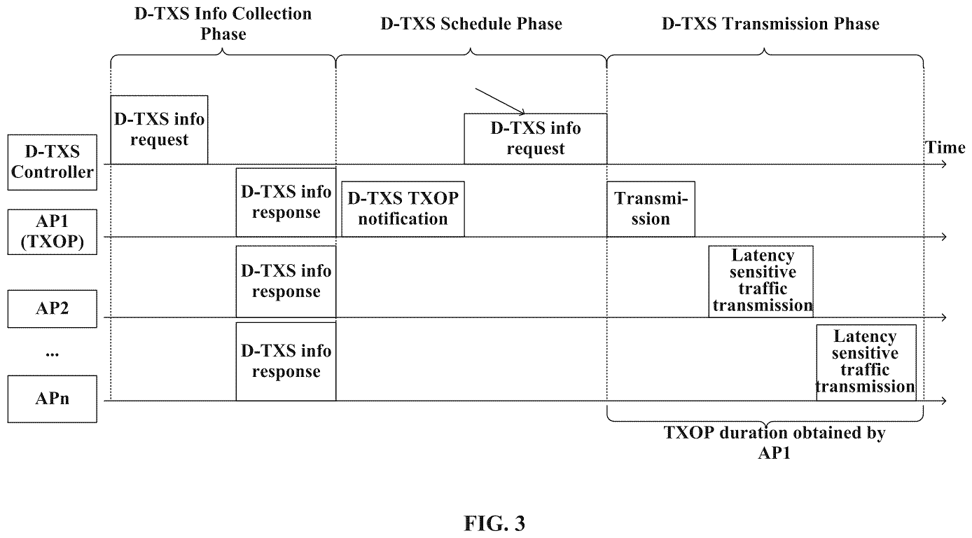

FIG. 3 is a diagram of an implementation of a D-TXS process according to an embodiment of the present application. As shown in FIG. 3, the D-TXS process in this embodiment includes a D-TXS information collection phase (also referred to as the D-TXS info collection phase), a D-TXS schedule phase, and a D-TXS transmission phase.

### First Phase: D-TXS Info Collection Phase

In S1, the D-TXS Controller actively sends a broadcast or unicast Transmission Opportunity Sharing Information Collection Request (D-TXS Info request) message to request each AP in the Transmission Opportunity Sharing Group (D-TXS group) to provide feedback on node-related information (D-TXS Info). In the embodiment, the node-related information includes, but is not limited to, uplink buffer information, priority information, low-latency information, and neighbor information.

In S2, each AP, based on the received D-TXS Info request, feeds back a Transmission Opportunity Sharing Information Collection Response message (D-TXS Info response message) to report node-related information to the D-TXS Controller. In the embodiment, the node-related information includes, but is not limited to, uplink buffer information, priority information, low-latency information, and neighbor information.

### Second Phase: D-TXS Schedule Phase

In S1, an AP (such as AP1) that successfully obtains a TXOP through channel contention access actively sends a Transmission Opportunity Sharing Notification (D-TXS TXOP Notification) to the D-TXS Controller to inform the D-TXS Controller of the successful channel contention access. The D-TXS TXOP Notification carries information including, but not limited to, timestamp information, the total duration of the transmission opportunity (total duration of the TXOP), and channel bandwidth information.

In S2, the D-TXS Controller divides the total duration of the TXOP into one or more allocation durations based on resource allocation judgment and informs each AP of the allocated allocation duration through a Transmission Opportunity Duration Allocation message (D-TXS TXOP Duration Allocation message) for subsequent low-latency transmission by the APs. The information carried in the TXOP Duration Allocation message includes, but is not limited to, timestamp information, channel bandwidth information, and allocation duration.

### Third Phase: D-TXS Transmission Phase

In S1, the AP (such as AP1) that successfully obtains the TXOP through channel contention access guides other APs to perform transmission within the allocated allocation duration.

In S2, when the allocated allocation duration expires, the original AP (that is, the AP that successfully obtains the TXOP through channel contention access, such as AP1) may choose to continue transmission until the TXOP expires or choose to terminate the TXOP early.

In the traditional transmission process of an MU-RTS/CTS message, channel reservation for multiple STAs in a single BSS and resolution of the problem of hidden nodes can be achieved. In embodiments of the present application, the MU-RTS/CTS message may be extended to a multi-BSS system so that a primary AP can trigger a variant MU-RTS/CTS message to guide a subordinate AP to complete channel reservation and resolve the problem of hidden nodes. Additionally, resource allocation messages in D-TXS may be integrated into the variant MU-RTS/CTS message, thereby reducing the redundancy of message interactions. Two allocation methods, real-time allocation, and reservation allocation, are distinguished to implement D-TXS transmission. Finally, different processing flows are configured for scenarios where the subordinate AP completes transmission early or fails to transmit.

In an embodiment, FIG. 4 is a flowchart of a data transmission method according to an embodiment of the present application. This embodiment applies to communication interactions between communication nodes in multiple BSSs. This embodiment may be executed by a first communication node located in a first basic service set. The data transmission method in this embodiment is performed during the D-TXS transmission phase as shown in FIG. 3. Exemplarily, the first communication node may be an AP. As shown in FIG. 4, this embodiment includes S410.

In S410, a multi-user request-to-send message is sent to a communication node in a second basic service set to enable the communication node in the second basic service set to perform data transmission.

In an embodiment, the second basic service set has an overlapping communication coverage range with the first basic service set. Exemplarily, the first communication node in the first basic service set may also be located in the second basic service set while being in the first basic service set. In the embodiment, the first communication node in the first basic service set may send a multi-user request-to-send message to communication nodes in other basic service sets so that the first communication node triggers the multi-user request-to-send message to guide communication nodes in other basic service sets to complete channel reservation and resolve the problem of hidden nodes.

In an embodiment, the multi-user request-to-send message carries at least a distributed transmission opportunity sharing service period (that is, D-TXS service period). In the embodiment, the multi-user request-to-send message may carry a resource allocation message (that is, time-domain resources and/or frequency-domain resources allocated by the first communication node to the communication node in the second basic service set). In an embodiment, when the multi-user request-to-send message carries time-domain resources, it may carry the distributed transmission opportunity sharing service period. In the embodiment, integrating the resource allocation message in D-TXS into the multi-user request-to-send message reduces the redundancy of message interactions. In the embodiment, the D-TXS service period refers to the total duration of data transmission allocated by the first basic service set to the communication node in the second basic service set. Upon receiving the multi-user request-to-send message carrying the D-TXS service period, the communication node in the second basic service set performs data transmission within the D-TXS service period. In an embodiment, when the multi-user request-to-send message carries a frequency-domain resource allocation message, collaborative orthogonal frequency-division multiplexing technology may be used to divide the frequency band resources of the first communication node into multiple sub-bands and allocate the multiple sub-bands to the communication node in the second basic service set for use. In the case of frequency band resource allocation, communication can only proceed after the elimination of hidden nodes is completed using the multi-user request-to-send message/clear-to-send message technology.

In an embodiment, the communication node in the second basic service set includes at least one of a second communication node or a third communication node, where the second communication node is of the same node type as the first communication node. Exemplarily, the second communication node may be an AP, and the third communication node may be an STA.

In an embodiment, after the multi-user request-to-send message is sent to the communication node in the second basic service set, the data transmission method applied to the first communication node in the first basic service set also includes receiving a clear-to-send message fed back by the communication node in the second basic service set. In the embodiment, the clear-to-send message is used to indicate whether the first communication node in the first basic service set has successfully allocated the D-TXS service period to the communication node in the second basic service set. In the embodiment, after the communication node in the second basic service set receives the multi-user request-to-send message, if the communication node in the second basic service set detects that the medium is idle, it responds with a CTS message to the first communication node within the SIFS time. Then, the communication node in the second basic service set uses the allocated time-domain or frequency-domain resources for low-latency data transmission. If the communication node in the second basic service set does not respond with a CTS message to the first communication node, the first communication node considers that the allocation of the D-TXS service period has failed, and the first communication node continues transmission and performs D-TXS allocation again at a later time.

In an embodiment, the allocation manner of the distributed transmission opportunity sharing service period includes one of a real-time allocation manner and a reservation allocation manner. In an embodiment, when the first communication node allocates time-domain resources (for example, the D-TXS service period) to the communication node in the second basic service set using the real-time allocation manner, the first communication node sends a multi-user request-to-send message carrying the D-TXS service period to the communication node in the second basic service set. After the communication node in the second basic service set receives the multi-user request-to-send message, if the communication node in the second basic service set detects that the medium is idle, it responds with a CTS message to the first communication node within the SIFS time. Then, the communication node in the second basic service set performs low-latency data transmission within the time-domain or frequency-domain resources carried in the multi-user request-to-send message. In an embodiment, when the first communication node allocates time-domain resources (for example, the D-TXS service period) to the communication node in the second basic service set using the reservation allocation manner, after receiving the multi-user request-to-send message, the communication node in the second basic service set responds with a CTS message and notifies other devices in the second basic service set through a broadcast action frame to be prohibited from obtaining a TXOP during the D-TXS service period and to complete TXOP transmission before the start time of the D-TXS service period.

In an embodiment, the frame structure of the multi-user request-to-send message includes at least one of an association identifier field, a resource unit allocation field, a basic service set identifier field, an allocation duration field, or a node identifier field. In the embodiment, a user information field matching the AP is added to the frame structure of the multi-user request-to-send message. In an embodiment, the user information field may include an association identifier field, a resource unit allocation field, a basic service set identifier field, and an allocation duration field. In an embodiment, the user information field may include a node identifier field, a resource unit allocation field, and an allocation duration field. In the embodiment, the information in the association identifier field and the basic service set identifier field is used to indicate that the user information points to a first communication node in an overlapping basic service set (OBSS), rather than an STA in the current BSS; the information in the resource unit allocation field is used to indicate spectrum information so that the communication node in the second basic service set responds with a CTS message on the spectrum, thereby completing the reservation and occupation of medium resources; the information in the allocation duration field is used to indicate the duration (that is, the total duration of the TXOP transmission window) allocated by the first communication node to the communication node in the second basic service set.

In an embodiment, the distributed transmission opportunity sharing service period is allocated to the communication node in the second basic service set using a reservation allocation manner; the frame structure of the multi-user request-to-send message also includes a service period start time field. In an embodiment, the frame structure of the multi-user request-to-send message includes an association identifier field, a resource unit allocation field, a basic service set identifier field, a service period start time field, and an allocation duration field. In an embodiment, the frame structure of the multi-user request-to-send message also includes a node identifier field, a resource unit allocation field, a service period start time field, and an allocation duration field. The information in the service period start time field is used to indicate the start time of the TXOP transmission window allocated to the communication node in the second basic service set.

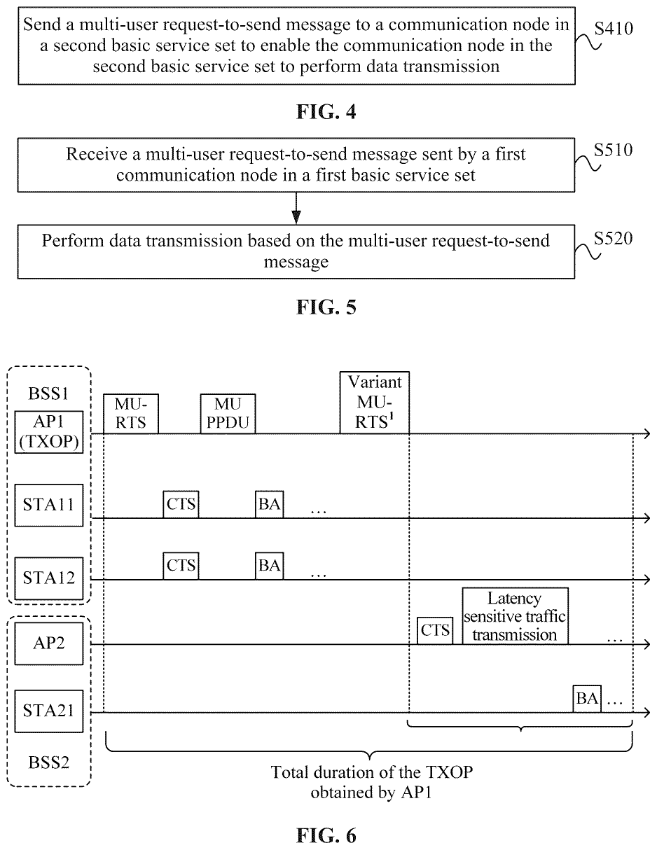

In an embodiment, FIG. 5 is a flowchart of another data transmission method according to an embodiment of the present application. This embodiment applies to communication interactions between communication nodes in multiple BSSs. This embodiment may be executed by a second communication node located in a second basic service set. Exemplarily, the second communication node may be an AP. As shown in FIG. 5, this embodiment includes S510 and S520.

In S510, a multi-user request-to-send message sent by a first communication node in a first basic service set is received.

In S520, data transmission is performed based on the multi-user request-to-send message.

In the embodiment, the communication node in the second basic service set receives the multi-user request-to-send message sent by the first communication node and performs data transmission based on the multi-user request-to-send message. In this manner, the first communication node can trigger the multi-user request-to-send message to guide communication nodes in other basic service sets to complete channel reservation and resolve the problem of hidden nodes.

In an embodiment, after the multi-user request-to-send message sent by the first communication node in the first basic service set is received, the method also includes sending a clear-to-send message to the first communication node in the first basic service set.

In an embodiment, the multi-user request-to-send message carries at least a distributed transmission opportunity sharing service period.

In an embodiment, the distributed transmission opportunity sharing service period is allocated by the first communication node using a reservation allocation manner; the data transmission method applied to the second communication node in the second basic service set also includes sending a broadcast action frame message to a third communication node in the second basic service set and the first communication node to cause the third communication node to be prohibited from obtaining a transmission opportunity during the distributed transmission opportunity sharing service period, or to cause the first communication node and the third communication node to complete transmission before the start time of the distributed transmission opportunity sharing service period. Exemplarily, the third communication node may be an STA. In the embodiment, after responding with a CTS message to the first communication node, the second communication node in the second basic service set notifies the third communication node in the second basic service set through a broadcast action frame message to be prohibited from obtaining a TXOP during the D-TXS service period and to ensure completion of TXOP transmission before the start time of the D-TXS service period. If a third communication node needs to contend for a TXOP and cannot complete TXOP transmission before the start time of the TXOP service period, the third communication node needs to abandon the TXOP and return to contending for a TXOP. In the embodiment, after the first communication node receives the broadcast action frame message, the first communication node performs transmission in the first basic service set and completes transmission before the start time of the D-TXS service period. The second communication node in the second basic service set obtains a TXOP at the start time of the D-TXS service period and performs transmission in the second basic service set.

In an embodiment, the broadcast action frame message includes at least one of a distributed transmission opportunity sharing service period element or a quiet element. In the embodiment, the quiet element is used to prevent access by other third communication nodes. In the embodiment, the broadcast action frame message includes the D-TXS service period and also includes a quiet element. In the embodiment, the quiet element is used to cover the start time of the D-TXS service period and lasts for a period of time.

In an embodiment, the distributed transmission opportunity sharing service period element includes at least one of a service period start time field or an allocation duration field; the quiet element includes at least one of a channel quiet start time field or a channel quiet duration field.

In the embodiment, the information in the channel quiet start time field is used to indicate the start time of channel quieting, and the information in the channel quiet duration field is used to indicate the duration of channel quieting. During the channel quiet duration, the third communication node in the second basic service set is prohibited from obtaining a TXOP.

In an embodiment, the allocation manner of the distributed transmission opportunity sharing service period includes one of a real-time allocation manner and a reservation allocation manner.

In an embodiment, the frame structure of the multi-user request-to-send message includes at least one of an association identifier field, a resource unit allocation field, a basic service set identifier field, an allocation duration field, or a node identifier field.

In an embodiment, the distributed transmission opportunity sharing service period is allocated by the first communication node using a reservation allocation manner; the frame structure of the multi-user request-to-send message also includes a service period start time field.

For the explanation of parameters such as the first basic service set, the second basic service set, the multi-user request-to-send message, the clear-to-send message, the D-TXS service period, and the frame structure of the multi-user request-to-send message in the embodiments of the data transmission method applied to the second communication node in the second basic service set, reference may be made to the description of the corresponding parameters in the embodiments of the data transmission method applied to the first communication node in the first basic service set, which will not be repeated here.

In an embodiment, FIG. 6 is a diagram of communication for real-time allocation of a D-TXS service period according to an embodiment of the present application. With an example where the first basic service set is BSS1, the second basic service set is BSS2, the first communication node is AP1, the second communication node is AP2, and the third communication node is STA21, the process of AP1 allocating a D-TXS service period to AP2 in real-time is described. In the embodiment, the multi-user request-to-send message using the real-time allocation manner is denoted as a variant MU-RTS¹ message. As shown in FIG. 6, the implementation process of real-time allocation of the D-TXS service period is as follows:

First, AP1 sends a variant MU-RTS¹ message at the start time of the D-TXS service period allocated to AP2. The variant MU-RTS¹ message includes information such as the allocation duration allocated to AP2.

Then, after AP2 receives the variant MU-RTS¹ message, if AP2 detects that the medium is idle, it responds with a CTS message to AP1 after the SIFS time and then performs low-latency transmission communication within the BSS (BSS2) during the service period window.

If AP2 does not respond with a CTS message, AP1 considers that the current D-TXS allocation has failed, and AP1 continues transmission or performs D-TXS allocation again at a later time.

During the D-TXS service period phase of AP2, AP1 listens at the Transmission Point Coordination Function interframe space (TxPIFS) after receiving each message. If AP1 finds the medium idle, it considers that the D-TXS service period transmission of AP2 is completed or has failed, and AP1 obtains the TXOP for transmission or terminates the TXOP early.

In the embodiment, the implementation process of allocating resources to AP2 using the real-time allocation manner is simple and does not require reserving resources in advance.

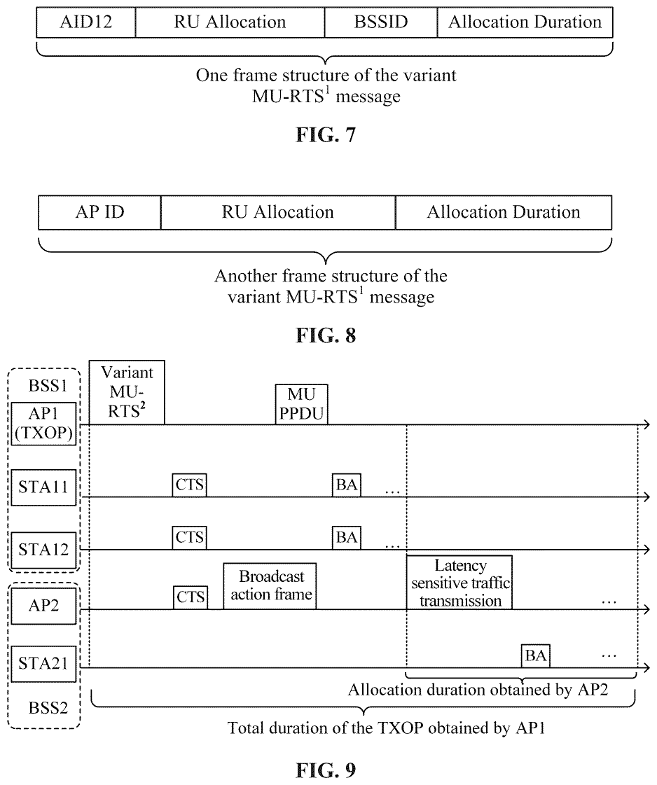

In an embodiment, FIG. 7 is a diagram of a frame structure of a multi-user request-to-send message according to an embodiment of the present application. As shown in FIG. 7, the multi-user request-to-send message sent using the real-time allocation manner is denoted as a variant MU-RTS¹ message, and the frame structure of the variant MU-RTS¹ message (that is, the user information field) includes at least an association identifier field (denoted as AID12 field), a resource unit allocation field (denoted as RU Allocation field), a basic service set identifier field (denoted as BSSID field), and an allocation duration field (denoted as Allocation Duration field).

In the embodiment, the information in the AID12 field and the BSSID field is used to collectively indicate that the user info points to an AP in an OBSS, rather than an STA in the current BSS.

The RU Allocation field is used to indicate spectrum information, requiring the AP to respond with a CTS message on the spectrum to complete the reservation and occupation of medium resources.

The Allocation Duration field is used to indicate the TXOP transmission window time allocated by the sender of the variant MU-RTS¹ message (that is, AP1) to the OBSS AP.

In an embodiment, FIG. 8 is a diagram of another frame structure of a multi-user request-to-send message according to an embodiment of the present application. As shown in FIG. 8, the multi-user request-to-send message sent using the real-time allocation manner is denoted as a variant MU-RTS¹ message, and the frame structure of the variant MU-RTS¹ message includes at least a node identifier field (denoted as APID field), a resource unit allocation field (denoted as RU Allocation field), and an allocation duration field (denoted as Allocation Duration field).

In the embodiment, the APID field is used to indicate that the user info points to an AP in an OBSS, rather than an STA in the current BSS.

The RU Allocation field is used to indicate spectrum information, requiring the AP to respond with a CTS message on the spectrum to complete the reservation and occupation of medium resources.

The Allocation Duration field is used to indicate the TXOP transmission window time allocated by the sender of the variant MU-RTS¹ message (that is, AP1) to the OBSS AP.

In an embodiment, FIG. 9 is a diagram of communication for reservation allocation of a D-TXS service period according to an embodiment of the present application. With an example where the first basic service set is BSS1, the second basic service set is BSS2, the first communication node is AP1, the second communication node is AP2, and the third communication node is STA21, the process of AP1 reserving a D-TXS service period for AP2 is described. In the embodiment, the multi-user request-to-send message using the reservation allocation manner is denoted as a variant MU-RTS² message. As shown in FIG. 9, the implementation process of reservation allocation of the D-TXS service period is as follows:

First, when AP1 obtains a TXOP for transmission, it uses a variant MU-RTS²/CTS message instead of the traditional MU-RTS/CTS message. The variant MU-RTS² message includes information about the D-TXS service period allocated to AP2.

Then, after responding with a CTS message, AP2 sends a broadcast action frame message to notify other devices in BSS2 not to obtain a TXOP during the D-TXS service period and to complete TXOP transmission before the D-TXS service period start time. If a certain STA needs to contend for a TXOP but cannot complete TXOP transmission within the time period before the D-TXS service period start time, the STA needs to abandon the TXOP and back off to contend for a TXOP again. The broadcast action frame message includes not only the D-TXS service period element (used to announce D-TXS information) but also a quiet element (used to cover the start time, with a quiet duration of 1 ms) to prevent access by legacy STAs.

Then, after receiving the broadcast action frame, AP1 performs transmission in its BSS (BSS1) and completes transmission before the D-TXS service period start time.

Finally, AP2 obtains a TXOP at the D-TXS service period start time and performs transmission in its BSS (BSS2).

During the D-TXS service period phase of AP2, AP1 listens at the TxPIFS after receiving each message. If AP1 finds the medium idle, it considers that the D-TXS service period transmission of AP2 is completed or has failed, and AP1 obtains the TXOP for transmission or terminates the TXOP early.

Using the reservation allocation manner to allocate the D-TXS service period to the communication node in the second basic service set allows resource allocation to be performed in advance through the MU-RTS/CTS message when AP1 obtains the TXOP. The broadcast action frame notifies the D-TXS service period in advance, improving the success rate of AP2 occupying the service period for transmission (preventing a situation where resource allocation starts after the MU-RTS/CTS message, but a certain STA contends for a TXOP and occupies the D-TXS service period of AP2).

Additionally, no situation exists where an STA continuously obtains a TXOP because the CTS message responded by AP2 indicates that the medium in BSS2 is idle.

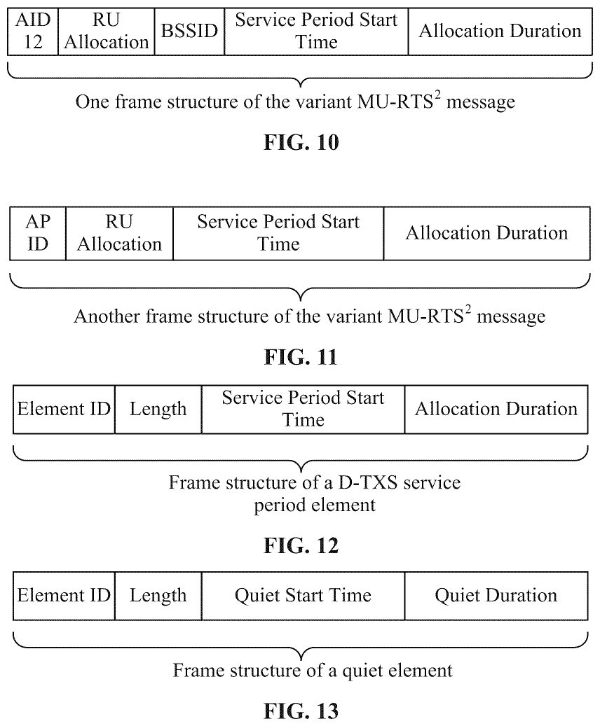

In an embodiment, FIG. 10 is a diagram of yet another frame structure of a multi-user request-to-send message according to an embodiment of the present application. As shown in FIG. 10, the multi-user request-to-send message sent using the reservation allocation manner is denoted as a variant MU-RTS² message, and the frame structure of the variant MU-RTS² message includes at least an association identifier field (denoted as AID12 field), a resource unit allocation field (denoted as RU Allocation field), a basic service set identifier field (denoted as BSSID field), a service period start time field (denoted as Service Period Start Time field), and an allocation duration field (denoted as Allocation Duration field).

In the embodiment, the AID12 field and the BSSID field collectively indicate that the user info points to an AP in an OBSS, rather than an STA in the current BSS.

The RU Allocation field is used to indicate spectrum information, enabling the AP to respond with a CTS message on the spectrum to complete the reservation and occupation of medium resources.

The Service Period Start Time field is used to indicate the start time of the TXOP transmission window allocated to the OBSS AP.

The Allocation Duration field is used to indicate the TXOP transmission window time allocated by the sender of the variant MU-RTS² message to the OBSS AP.

In an embodiment, FIG. 11 is a diagram of still another frame structure of a multi-user request-to-send message according to an embodiment of the present application. As shown in FIG. 11, the multi-user request-to-send message sent using the reservation allocation manner is denoted as a variant MU-RTS² message, and the frame structure of the variant MU-RTS² message includes at least a node identifier field (denoted as APID), a resource unit allocation field (denoted as RU Allocation field), a service period start time field (denoted as Service Period Start Time field), and an allocation duration field (denoted as Allocation Duration field).

In the embodiment, the APID field is used to indicate that the user info points to an AP in an OBSS, rather than an STA in the current BSS.

The RU Allocation field is used to indicate spectrum information, enabling the AP to respond with a CTS message on the spectrum to complete the reservation and occupation of medium resources.

The Service Period Start Time field is used to indicate the start time of the TXOP transmission window allocated to the OBSS AP.

The Allocation Duration field is used to indicate the TXOP transmission window time allocated by the sender of the variant MU-RTS2 message to the OBSS AP.

In an embodiment, the broadcast action frame message includes a D-TXS service period element and a quiet element. In an embodiment, FIG. 12 is a diagram of a frame structure of a D-TXS service period element according to an embodiment of the present application. As shown in FIG. 12, the D-TXS service period element includes at least a service period start time field (denoted as a Service Period Start Time field) and an allocation duration field (denoted as an Allocation Duration field).

In the embodiment, the Service Period Start Time field is used to indicate the start time of the TXOP transmission window obtained by the AP through D-TXS.

The Allocation Duration field is used to indicate the duration of the TXOP transmission window.

In an embodiment, FIG. 13 is a diagram of a frame structure of a quiet element according to an embodiment of the present application. As shown in FIG. 13, the quiet element includes at least a channel quiet start time field (denoted as Quiet Start Time field) and a channel quiet duration field (denoted as Quiet Duration field).

In the embodiment, the Quiet Start Time field is used to indicate the start time of channel quieting, and the Quiet Duration field is used to indicate the duration of channel quieting.

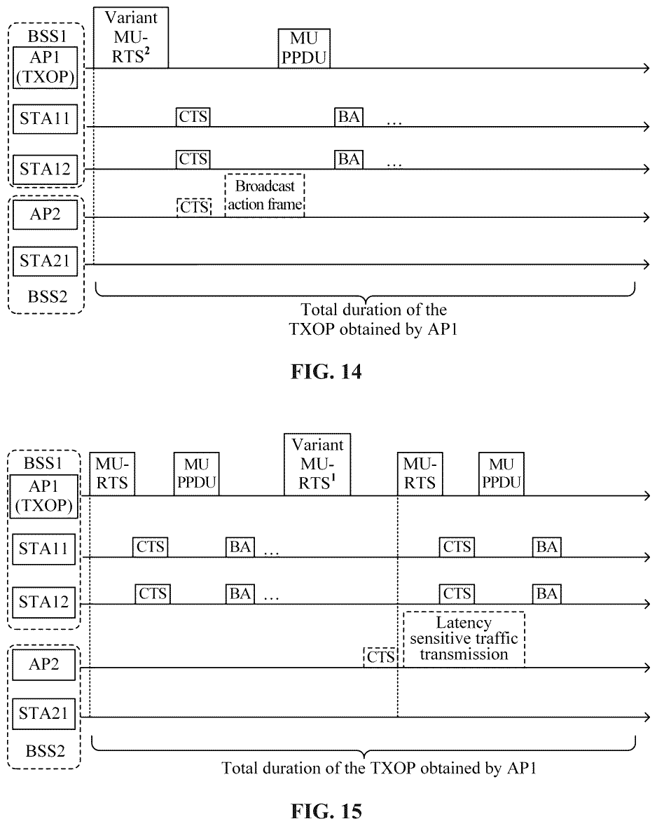

In an embodiment, FIG. 14 is a diagram of communication interactions between a variant MU-RTS message and a CTS message according to an embodiment of the present application. With an example where the first basic service set is BSS1, the second basic service set is BSS2, the first communication node is AP1, the second communication node is AP2, and the third communication node is STA21, the process of AP1 failing to allocate a D-TXS service period to AP2 using the reservation allocation manner is described. In the embodiment, the multi-user request-to-send message using the reservation allocation manner is denoted as a variant MU-RTS² message. As shown in FIG. 14, the implementation process of reservation allocation of the D-TXS service period is as follows:

AP1 sends a variant MU-RTS² message to AP2, where the variant MU-RTS² message carries information about the D-TXS service period allocated to AP2, and AP2 fails to respond with a CTS message (for example, AP2 is communicating with STA21). After failing to receive the CTS message and the broadcast action frame, AP1 confirms that this D-TXS allocation has failed, and AP1 continues transmission communication in BSS1 during the remaining TXOP.

In an embodiment, FIG. 15 is a diagram of another communication interaction between a variant MU-RTS message and a CTS message according to an embodiment of the present application. With an example where the first basic service set is BSS1, the second basic service set is BSS2, the first communication node is AP1, the second communication node is AP2, and the third communication node is STA21, the process of AP1 failing to allocate a D-TXS service period to AP2 using the real-time allocation manner is described. In the embodiment, the multi-user request-to-send message using the real-time allocation manner is denoted as a variant MU-RTS¹ message. As shown in FIG. 15, the implementation process of real-time allocation of the D-TXS service period is as follows:

AP1 sends a variant MU-RTS¹ message to AP2, where the variant MU-RTS¹ message carries information about the D-TXS service period allocated to AP2, and AP2 fails to respond with a CTS message (for example, AP2 is communicating with STA21). After failing to receive the CTS message, AP1 confirms that this D-TXS allocation has failed, and AP1 continues transmission communication in BSS1 during the remaining TXOP.

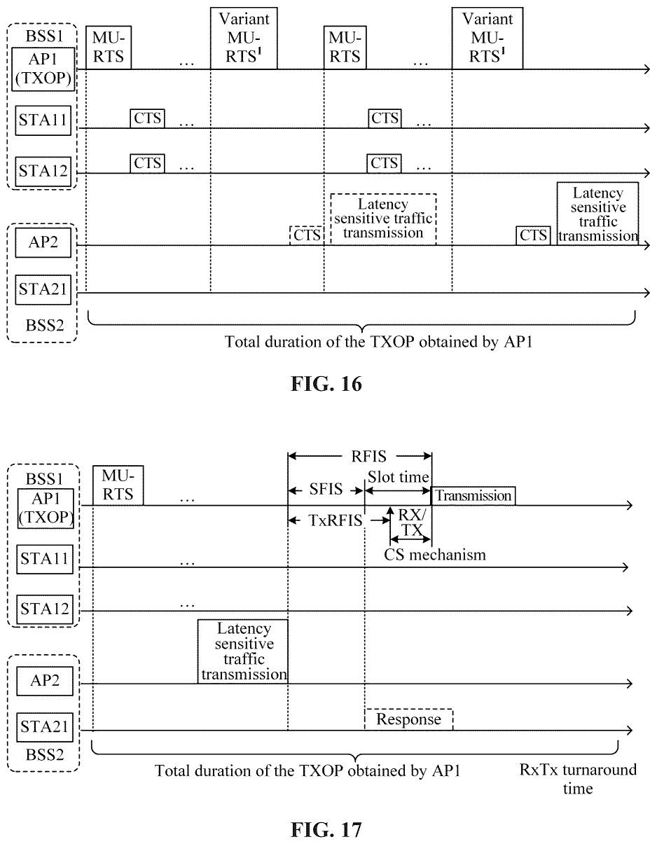

In an embodiment, FIG. 16 is a diagram of yet another communication interaction between a variant MU-RTS message and a CTS message according to an embodiment of the present application. With an example where the first basic service set is BSS1, the second basic service set is BSS2, the first communication node is AP1, the second communication node is AP2, and the third communication node is STA21, the process of AP1 failing to allocate a D-TXS service period to AP2 using the real-time allocation manner is described. In the embodiment, the multi-user request-to-send message using the real-time allocation manner is denoted as a variant MU-RTS¹ message. As shown in FIG. 16, the implementation process of real-time allocation of the D-TXS service period is as follows:

AP1 sends a variant MU-RTS¹ message to AP2, where the variant MU-RTS¹ message carries information about the D-TXS service period allocated to AP2, and AP2 fails to respond with a CTS message (for example, AP2 is communicating with STA21). After failing to receive the CTS message, AP1 confirms that this D-TXS allocation has failed, and AP1 triggers the variant MU-RTS¹ message again during the remaining TXOP to allocate a time-domain window to guide AP2 for transmission.

In an embodiment, FIG. 17 is a diagram illustrating that a primary AP performs medium detection during a service period of a subordinate AP according to an embodiment of the present application. With an example where the first basic service set is BSS1, the second basic service set is BSS2, the first communication node is AP1, the second communication node is AP2, the third communication node is STA21, the primary AP is AP1, and the subordinate AP is AP2, the process of the primary AP performing medium detection during the service period of the subordinate AP is described. As shown in FIG. 17, the communication process of the primary AP performing medium detection during the service period of the subordinate AP is as follows:

During the D-TXS service period phase of AP2, AP1 performs carrier sense (including virtual carrier sense and physical carrier sense) at the TxPIFS after receiving each message. If the medium is confirmed to be idle, AP1 considers that the D-TXS service period transmission of AP2 is completed or has failed, and AP1 obtains the TXOP for transmission.

In the embodiment of the present application, TxPIFS is the difference between PIFS and RxTxTurnaroundTime.

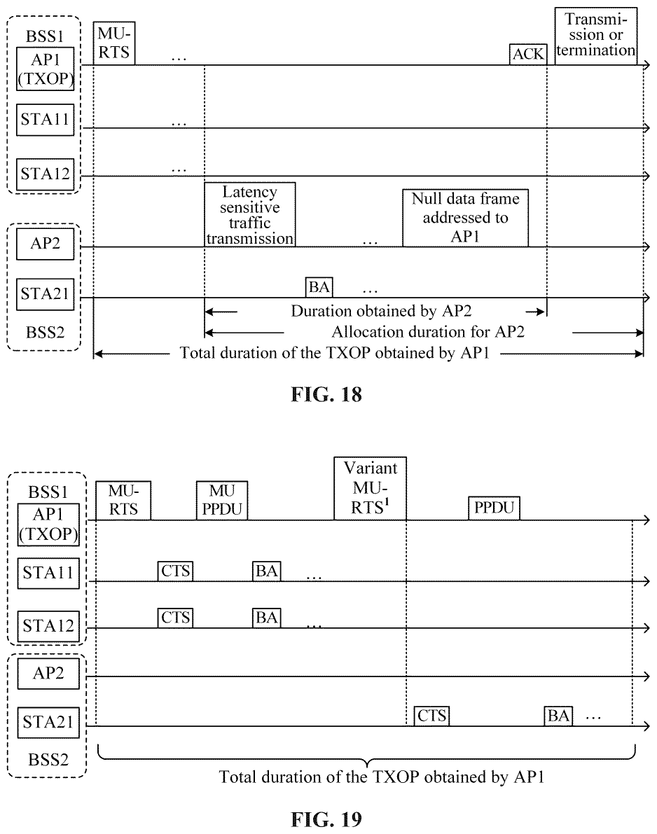

In an embodiment, FIG. 18 is a diagram of an implementation of a transmission completion notification of a subordinate AP according to an embodiment of the present application. With an example where the first basic service set is BSS1, the second basic service set is BSS2, the first communication node is AP1, the second communication node is AP2, the third communication node is STA21, the primary AP is AP1, and the subordinate AP is AP2, the process of the transmission completion notification of the subordinate AP is described. As shown in FIG. 18, the communication process of the transmission completion notification of the subordinate AP is as follows:

AP2 completes transmission early during the allocated D-TXS service period and actively sends a Null Data frame to AP1 to inform that the TXOP transmission is completed early. After AP1 responds with an ACK confirmation, AP1 obtains the remaining TXOP time for transmission or terminates the TXOP.

In an embodiment, FIG. 19 is a diagram of communication between APs and STAs across BSSs according to an embodiment of the present application. With an example where the first basic service set is BSS1, the second basic service set is BSS2, the first communication node is AP1, the second communication node is AP2, and the third communication node is STA21, the communication interaction process between APs and STAs across BSSs is described. In the embodiment, AP1 sends a multi-user request-to-send message to STA21 using the real-time allocation manner, and the multi-user request-to-send message sent using the real-time allocation manner is denoted as a variant MU-RTS¹ message. As shown in FIG. 19, the communication process between APs and STAs across BSSs is as follows:

The variant MU-RTS¹ message sent by AP1 carries information about the D-TXS service period allocated to STA21; after STA21 successfully responds with a CTS message, AP1 communicates with STA21 in the allocated time domain.

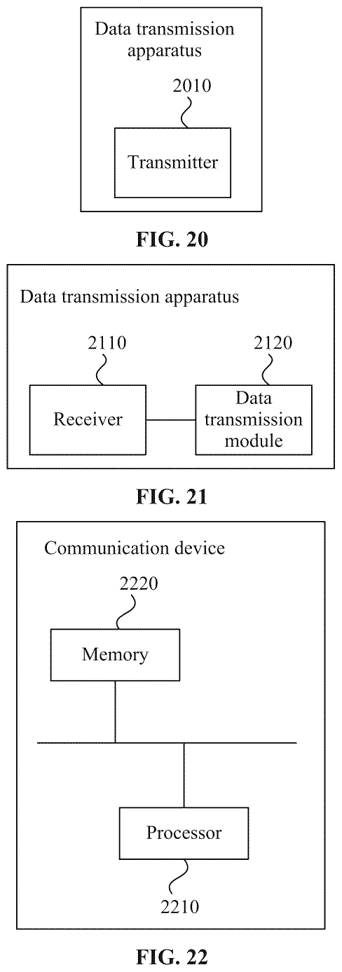

In an embodiment, FIG. 20 is a block diagram illustrating the structure of a data transmission apparatus according to an embodiment of the present application. This embodiment applies to a first communication node located in a first basic service set. As shown in FIG. 20, the data transmission apparatus in this embodiment includes a transmitter 2010.

The transmitter 2010 is configured to send a multi-user request-to-send message to a communication node in a second basic service set to enable the communication node in the second basic service set to perform data transmission.

In an embodiment, the second basic service set has an overlapping communication coverage range with the first basic service set.

In an embodiment, the multi-user request-to-send message carries at least a distributed transmission opportunity sharing service period.

In an embodiment, the communication node in the second basic service set includes at least one of a second communication node or a third communication node, where the second communication node is of the same node type as the first communication node.

In an embodiment, after the multi-user request-to-send message is sent to the communication node in the second basic service set, the data transmission apparatus applied to the first communication node in the first basic service set also includes a receiver.

The receiver is configured to receive a clear-to-send message fed back by the communication node in the second basic service set.

In an embodiment, the allocation manner of the distributed transmission opportunity sharing service period includes one of a real-time allocation manner and a reservation allocation manner.

In an embodiment, the frame structure of the multi-user request-to-send message includes at least one of an association identifier field, a resource unit allocation field, a basic service set identifier field, an allocation duration field, or a node identifier field.

In an embodiment, the distributed transmission opportunity sharing service period is allocated to the communication node in the second basic service set using a reservation allocation manner; the frame structure of the multi-user request-to-send message also includes a service period start time field.

The data transmission apparatus provided in this embodiment is configured to implement the data transmission method applied to the first communication node in the first basic service set in the embodiment as shown in FIG. 4. The data transmission apparatus provided in this embodiment has similar implementation principles and technical effects, which are not repeated here.

In an embodiment, FIG. 21 is a block diagram illustrating the structure of another data transmission apparatus according to an embodiment of the present application. This embodiment applies to a second communication node located in a second basic service set. As shown in FIG. 21, the data transmission apparatus in this embodiment includes a receiver 2110 and a data transmission module 2120.

The receiver 2110 is configured to receive a multi-user request-to-send message sent by a first communication node in a first basic service set. The data transmission module 2120 is configured to perform data transmission based on the multi-user request-to-send message.

In an embodiment, the second basic service set has an overlapping communication coverage range with the first basic service set.

In an embodiment, after the multi-user request-to-send message sent by the first communication node in the first basic service set is received, the apparatus also includes a transmitter.

The transmitter is configured to send a clear-to-send message to the first communication node in the first basic service set.

In an embodiment, the multi-user request-to-send message carries at least a distributed transmission opportunity sharing service period.

In an embodiment, the distributed transmission opportunity sharing service period is allocated by the first communication node using a reservation allocation manner, and the data transmission apparatus applied to the second communication node in the second basic service set also includes a transmitter.

The transmitter is further configured to send a broadcast action frame message to a third communication node in the second basic service set and the first communication node to cause the third communication node to be prohibited from obtaining a transmission opportunity during the distributed transmission opportunity sharing service period, or to cause the first communication node and the third communication node to complete transmission before the start time of the distributed transmission opportunity sharing service period.

In an embodiment, the broadcast action frame message includes at least one of a distributed transmission opportunity sharing service period element or a quiet element.

In an embodiment, the distributed transmission opportunity sharing service period element includes at least one of a service period start time field or an allocation duration field; the quiet element includes at least one of a channel quiet start time field or a channel quiet duration field.

In an embodiment, the allocation manner of the distributed transmission opportunity sharing service period includes one of a real-time allocation manner and a reservation allocation manner.

In an embodiment, the frame structure of the multi-user request-to-send message includes at least one of an association identifier field, a resource unit allocation field, a basic service set identifier field, an allocation duration field, or a node identifier field.

In an embodiment, the distributed transmission opportunity sharing service period is allocated by the first communication node using a reservation allocation manner; the frame structure of the multi-user request-to-send message also includes a service period start time field.

The data transmission apparatus provided in this embodiment is configured to implement the data transmission method applied to the second communication node in the second basic service set in the embodiment as shown in FIG. 5. The data transmission apparatus provided in this embodiment has similar implementation principles and technical effects, which are not repeated here.

In an embodiment, FIG. 22 is a diagram illustrating the structure of a communication device according to an embodiment of the present application. As shown in FIG. 22, the device provided in the present application includes a processor 2210 and a memory 2220. One or more processors 2210 may be included in the device. One processor 2210 is shown as an example in FIG. 22. One or more memories 2220 may be provided in the device. One memory 2220 is shown as an example in FIG. 22. The processor 2210 and memory 2220 of the device may be connected by a bus or in other manners. The connection by a bus is taken as an example in FIG. 22. In this embodiment, the device may be a resource management component.

The memory 2220, as a computer-readable storage medium, may be configured to store software programs, computer-executable programs, and modules, such as program instructions/modules (for example, the transmitter 2010 in the data transmission apparatus applied to the first communication node in the first basic service set) corresponding to the device in any embodiment of the present application. The memory 2220 may include a program storage region and a data storage region. The program storage region may store an operating system and an application program required by at least one function. The data storage region may store data created according to the use of the device. Moreover, the memory 2220 may include a high-speed random-access memory and may also include a non-volatile memory such as at least one magnetic disk memory, a flash memory, or another non-volatile solid-state memory. In some examples, the memory 2220 may include memories that are remotely disposed relative to the processor 2210, and these remote memories may be connected to the device via a network. Examples of the preceding network include but are not limited to, the Internet, an intranet, a local area network, a mobile communication network, and a combination thereof.

When the communication device is a first communication node located in a first basic service set, the device provided above may be configured to execute the data transmission method applied to the first communication node in the first basic service set provided by any of the preceding embodiments and has corresponding functions and effects.

When the communication device is a second communication node located in a second basic service set, the device provided above may be configured to execute the data transmission method applied to the second communication node in the second basic service set provided by any of the preceding embodiments and has corresponding functions and effects.

An embodiment of the present application also provides a storage medium containing computer-executable instructions, which, when executed by a computer processor, are used to perform a data transmission method applied to a first communication node in a first basic service set. The method includes sending a multi-user request-to-send message to a communication node in a second basic service set to enable the communication node in the second basic service set to perform data transmission.

An embodiment of the present application also provides a storage medium containing computer-executable instructions, which, when executed by a computer processor, are used to perform a data transmission method applied to a second communication node in a second basic service set. The method includes receiving a multi-user request-to-send message sent by a first communication node in a first basic service set and performing data transmission based on the multi-user request-to-send message.

It is to be understood by those skilled in the art that the term “user equipment” covers any suitable type of wireless user equipment, for example, a mobile phone, a portable data processing apparatus, a portable web browser, or a vehicle-mounted mobile station.

Generally speaking, various embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source or object codes written in any combination of one or more programming languages.

A block diagram of any logic flow among the drawings of the present application may represent program procedures, may represent interconnected logic circuits, modules, and functions, or may represent a combination of program procedures with logic circuits, modules, and functions. Computer programs may be stored in a memory. The memory may be of any type suitable for a local technical environment and may be implemented using any suitable data storage technology such as, but not limited to, a read-only memory (ROM), a random-access memory (RAM), or an optical memory device and system (a digital video disc (DVD), or a compact disc (CD)). The computer-readable medium may include a non-transitory storage medium. The data processor may be of any type suitable for a local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

1. A data transmission method, the method being applied to a first communication node in a first basic service set and comprising:
sending a multi-user request-to-send message to a communication node in a second basic service set to enable the communication node in the second basic service set to perform data transmission.

2. The data transmission method according to claim 1, wherein the second basic service set has an overlapping communication coverage range with the first basic service set.

3. The data transmission method according to claim 1, wherein the multi-user request-to-send message carries at least a distributed transmission opportunity sharing service period.

4. The data transmission method according to claim 1, wherein the communication node in the second basic service set comprises at least one of: a second communication node or a third communication node; wherein the second communication node is of a same node type as the first communication node.

5. The data transmission method according to claim 1, after sending the multi-user request-to-send message to the communication node in the second basic service set, further comprising:
receiving a clear-to-send message fed back by the communication node in the second basic service set.

6. The data transmission method according to claim 3, wherein an allocation manner of the distributed transmission opportunity sharing service period comprises one of: a real-time allocation manner and a reservation allocation manner.

7. The data transmission method according to claim 1, wherein a frame structure of the multi-user request-to-send message comprises at least one of: an association identifier field, a resource unit allocation field, a basic service set identifier field, an allocation duration field, or a node identifier field.

8. The data transmission method according to claim 1, wherein the distributed transmission opportunity sharing service period is allocated to the communication node in the second basic service set using a reservation allocation manner; and a frame structure of the multi-user request-to-send message comprises a service period start time field.

9. A data transmission method, the method being applied to a second communication node located in a second basic service set and comprising:
receiving a multi-user request-to-send message sent by a first communication node in a first basic service set; and
performing data transmission based on the multi-user request-to-send message.

10. The data transmission method according to claim 9, after receiving the multi-user request-to-send message sent by the first communication node in the first basic service set, further comprising:
sending a clear-to-send message to the first communication node in the first basic service set.

11. The data transmission method according to claim 9, wherein the multi-user request-to-send message carries at least a distributed transmission opportunity sharing service period.

12. The data transmission method according to claim 11, wherein the distributed transmission opportunity sharing service period is allocated by the first communication node using a reservation allocation manner; and the method further comprises:
sending a broadcast action frame message to a third communication node in the second basic service set and the first communication node to cause the third communication node to be prohibited from obtaining a transmission opportunity during the distributed transmission opportunity sharing service period, or to cause the first communication node and the third communication node to complete transmission before a start time of the distributed transmission opportunity sharing service period.

13. The data transmission method according to claim 12, wherein the broadcast action frame message comprises at least one of: a distributed transmission opportunity sharing service period element or a quiet element.

14. The data transmission method according to claim 13, wherein the distributed transmission opportunity sharing service period element comprises at least one of: a service period start time field or an allocation duration field; and
the quiet element comprises at least one of: a channel quiet start time field; and a channel quiet duration field.

15. A communication device, comprising: a memory and at least one processor; wherein
the memory is configured to store at least one program; and
the at least program, when executed by the at least one processor, causes the at least one processor to implement;
sending a multi-user request-to-send message to a communication node in a second basic service set to enable the communication node in the second basic service set to perform data transmission.

16. A non-transitory computer-readable storage medium storing a computer program, wherein the computer program, when executed by a processor, causes the processor to implement the data transmission method according to claim 1.

17. The communication device according to claim 15, wherein the second basic service set has an overlapping communication coverage range with the first basic service set.

18. The communication device according to claim 15, wherein the multi-user request-to-send message carries at least a distributed transmission opportunity sharing service period.

19. The communication device according to claim 15, wherein the communication node in the second basic service set comprises at least one of: a second communication node or a third communication node; wherein the second communication node is of a same node type as the first communication node.

20. The communication device according to claim 15, after sending the multi-user request-to-send message to the communication node in the second basic service set, the at least one processor further performs:
receiving a clear-to-send message fed back by the communication node in the second basic service set.
